(19) United States
(12) Patent Application Publication
(10) Pub. No.: US 2007/0177209 A1
(43) Pub. Date: Aug. 2, 2007

(54) Information processing apparatus and recording medium for storing program

(76) Inventors: Takei Ishibashi, Tokyo (JP); Michio Osada, Tokyo (JP)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/416,291

(22) Filed: May 1, 2006

(30) Foreign Application Priority Data
Feb. 1, 2006 (JP) 2006-024624

(51) Int. Cl. G06K 15/00

(52) U.S. Cl. 358/1.18

(57) ABSTRACT

Disclosed herein is an information processing apparatus including a controller for instructing printing of a spine for case binding based on data of a certain page in a data file including data of a plurality of pages.

### BACKGROUND OF THE INVENTION

1. Field of the Invention

The present invention relates to an information processing apparatus and a recording medium for storing a program, and particularly to such apparatus and program applied to case biding.

2. Description of Related Art

In recent years, digital printing machines have been introduced to the print industry. The digital printing machines are printing machines capable of directly performing printing based on computerized print data. Sheets printed by the digital printing machines are bound together to create books.

As an example of book binding, case binding has been known. In the case binding, book binding is performed so that a body section is wrapped with front and back covers. The front and back covers are imposed on a single sheet at the book binding. A case-bound book includes a cover section composed of a single sheet with the front and rear covers printed thereon and the body section composed of a plurality of sheets. When the book includes a spine, printing is performed with the spine which is included in the cover section.

In the case binding of the book including the spine, printing is performed based on character data of the spine, print data of the front and back covers, and print data of the body section. A technology is known which allows a user to specify fonts and size of characters printed on the spine when printing spine page data (for example, the Japanese Patent Laid-open Publication No. 2002-361967).

However, in the above conventional art, when printing books containing character data of the spine, the user had to input the character data of the spine at each time of printing. Moreover, the fonts and size of the characters printed on the spine could be specified. However, picture and photographic data and the like could not be specified.

### SUMMARY

An object of the present invention is to improve user's operability and create varied spines.

In order to achieve the above object, in accordance with an embodiment according to the first aspect of the present invention, an information processing apparatus comprises: a controller for instructing printing of a spine for case binding based on data of a certain page in a data file including data of a plurality of pages.

Preferably, the controller instructs printing of a body for the case binding based on data of at least a part of pages other than the certain page in the data file.

Preferably, the controller instructs printing of a front cover and a back cover for the case binding based on data of at least a part of pages other than the certain page in the data file.

Preferably, the information processing apparatus further comprises an input unit for accepting an input instruction from a user, wherein the controller specifies the certain page based on the input instruction accepted by the input unit.

Preferably, the input unit accepts an entry of a page number in the data file, and the controller specifies the certain page based on the page number accepted by the input unit.

According to another embodiment reflecting another aspect of the present invention, an image processing apparatus comprises: a controller for instructing printing of a spine for case binding based on data of a certain part in a data file including data based on which printing of a body for the case biding is to be instructed.

Preferably, the data fine includes data of a plurality of pages, and the certain part is a certain page of the plurality of pages. Alternatively, the data file preferably includes data for header and/or footer used as the certain part. Yet alternatively, data regarding a title of the data file is preferably applied as the certain part.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a block diagram showing a configuration of an image forming system 100 according to the present invention;

FIG. 2 is a block diagram showing an internal configuration of an information processing apparatus 1;

FIG. 3 is a block diagram showing an internal configuration of an image forming apparatus 2;

FIG. 4 is a schematic view of case binding;

FIG. 5 is a view showing a document file 17;

FIG. 6 is a view showing a setting screen for case binding;

FIG. 7 is a view showing print data 71;

FIG. 8 is a flowchart showing a print data transmission process;

FIG. 9A is a view explaining imposition processing in the case where case binding is “ON”, spine data is “INCLUDED”, spine page data is at the 7th page, and spine width is 5 mm;

FIG. 9B is a view explaining the imposition processing in the case where case binding is “ON”, spine data is “NOT INCLUDED”, and spine width is 5 mm;

FIG. 10A is a view explaining a case binding process; and

FIG. 10B is a flowchart showing the case binding process.

### DETAILED DESCRIPTION OF THE PREFERRED EMBODIMENT

Hereinafter, a description is given of an embodiment according to the present invention with reference to the accompanying drawings. However, the scope of the invention is not limited to examples shown in the drawings. For instance, although specific features relating to the embodiments described below are emphasized, the present invention is not bound by such emphasized features.

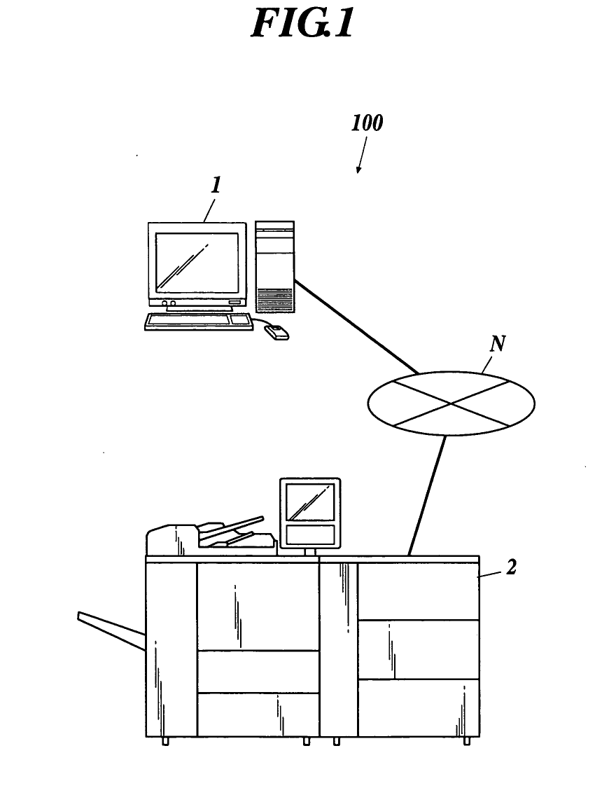

With reference to FIG. 1, an image forming system 100 of the embodiment is described. The image forming system 100 is a system which performs case binding after setting spine page data. The image forming system 1 includes an information processing apparatus 1 and an image forming apparatus 2. The information processing apparatus 1 and image forming apparatus 2 are communicatingly connected to each other through a communication network N.

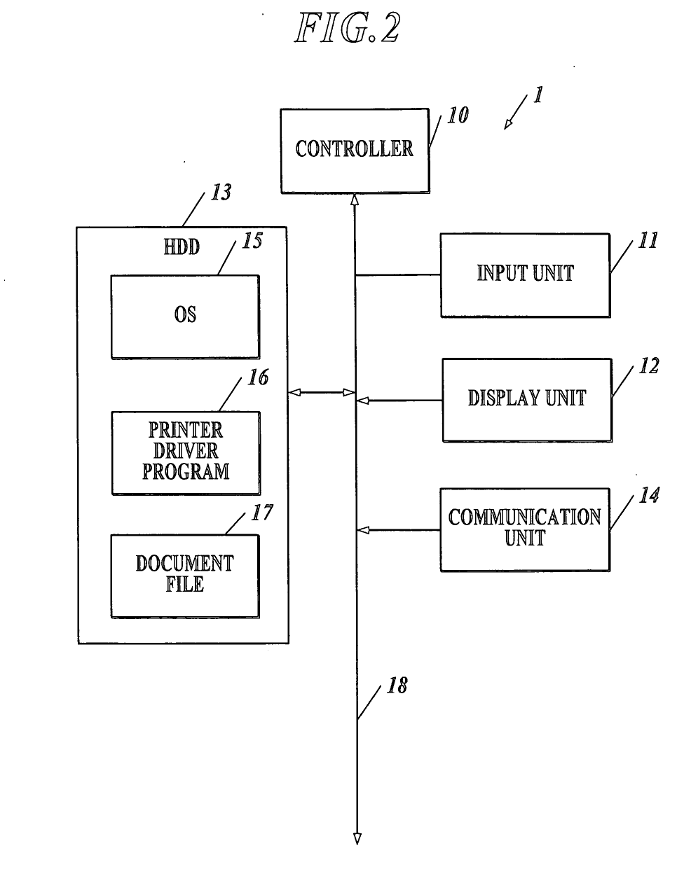

Next, the information processing apparatus 1 is described with reference to FIG. 2. The information processing apparatus 1 is a personal computer (PC) which sets the spine page data. The information processing apparatus 1 includes a controller 10, an input unit 11, a display unit 12, a hard disk drive (HDD) 13, and a communication unit 14, which are connected to each other through a bus 18.

The controller 10 includes a central processing unit (CPU), a random access memory (RAM), and the like and centrally controls each component of the information processing apparatus 1. The controller 10 loads a system program and various application programs stored in the HDD 13 into the RAM, and various types of processing are executed through cooperation of the programs loaded into the RAM and the CPU. The HDD 13, in particular, stores a later-described print data transmission program.

The controller 10 transmits print data 71 to the image forming apparatus 2 through cooperation with the later-described print data transmission program.

The input unit 11 includes a keyboard provided with cursor keys, numeric keys, various function keys, and the like. The input unit 11 outputs to the controller 10 depressing signals generated by an operator's depression of the keys of the keyboard. The input unit 11 may include a pointing device such as a mouse.

The display unit 12 includes a liquid crystal display (LCD), a cathode ray tube (CRT), or the like and displays a screen according to a display signal from the controller 10.

The HDD 13 is provided with a magnetic recording medium, and various types of information are stored in the magnetic recording medium through an instruction from the controller 10 so as to be readable and writable. The HDD 13 stores an operating system (OS) 15, a printer driver program 16, and a document file 17. The OS 15 is software managing the entire system of the information processing apparatus 1. The printer driver program 16 includes the later-described print data transmission program. The document file 17 as a data file includes a plurality of types of page data which are used for case binding. Details of the document file 17 are described later.

The communication unit 14 includes a modem, a terminal adapter (TA), a router, a network card, and the like and transmits and receives information to and from external equipment on the communication network N connected thereto, including the image forming apparatus 2.

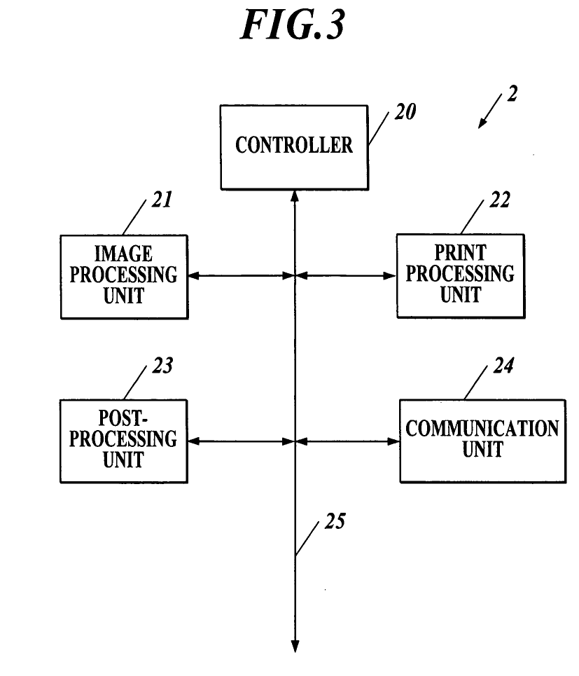

Next, the image forming apparatus 2 is described with reference to FIG. 3. The image forming apparatus 2 is an apparatus which performs case binding upon receiving the print data 71 with the spine page data set. The image forming apparatus 2 includes a controller 20, an image processing unit 21, a print processing unit 22, a post-processing unit 23, and a communication unit 24, which are connected to each other through a bus 25.

The controller 20 is composed of a CPU, a read only memory (ROM), a RAM, and the like and centrally controls each unit of the image forming apparatus 2. The controller 20 loads into the RAM a program specified among a system program and various application programs stored in the ROM, and various types of processing are executed through cooperation of the program loaded into the RAM and the CPU. The ROM, in particular, stores a later-described case binding program. The ROM may be substituted to electrically erasable programmable ROM (EEPROM) so that the programs stored therein can be updated according to need.

The controller 20 receives the print data 71 from the information processing apparatus 1 and carries out case binding through cooperation with the later-described case binding program. The controller 20 controls entire processing performed in the image processing unit 21, print processing unit 22, and post-processing unit 23.

The image processing unit 21 performs processing based on an image processing instruction and an imposition processing instruction transmitted from the controller 20. The image processing instruction is an instruction to convert each type of page data included in the print data 71 into printable image data and cause the print processing unit 22 to print the same. Herein, the print data 71 is data which is set so as to be interpreted by the image forming apparatus 2. The imposition processing instruction is an instruction to subject the print data 71 to imposition processing. The print data 71 and imposition processing are described later. The controller 20 may include all the functions that the image processing unit 21 includes.

The print processing unit 22 performs processing based on a print processing instruction transmitted by the controller 20. The print processing instruction is an instruction to print data subjected to image processing on a print medium. Herein, the print medium is, for example, a recording sheet or the like. The print processing unit 22 is composed of a printer including an electrophotographic printing or ink-jet printing function or the like.

The post-processing unit 23 performs processing based on a post-processing instruction transmitted by the controller 20. The post-processing instruction is an instruction to perform case binding for the print medium after printing. The post-processing unit 23 is composed of a book binding machine including a book binding function or the like.

The communication unit 24 includes a modem, a terminal adapter, a router, a network card, and the like and transmits and receives information to and from external equipment on the communication network N connected thereto, including the information processing apparatus 1.

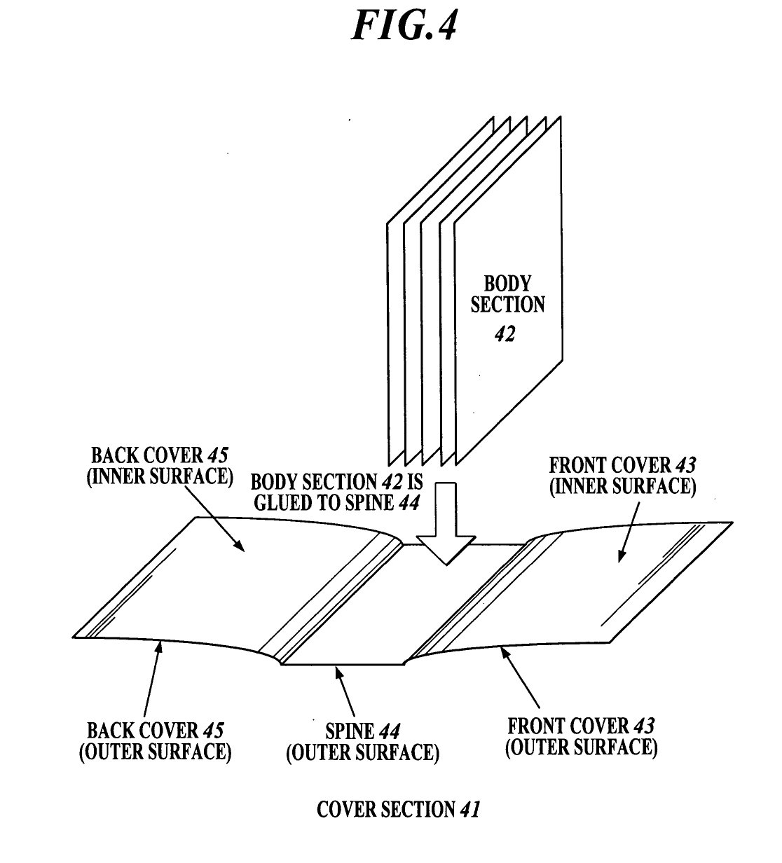

Next, a description is given of case binding with reference to FIG. 4. The book created by the case binding includes a cover section 41 composed of a single sheet and a body section 42 composed of a plurality of sheets. The cover section includes a single sheet with a front cover 43 and a back cover 45 imposed and printed thereon. The cover section 41 includes the front cover 43 (outer surface), the front cover 43 (inner surface), a spine 44, the back cover 45 (outer surface), and the back cover 45 (inner surface). The body section 42 is glued to the spine 44.

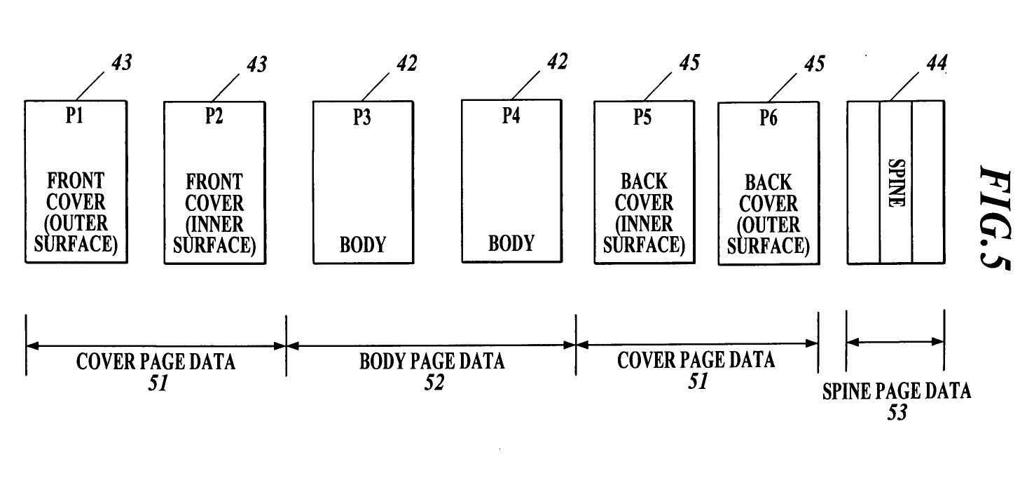

Next, the document file 17 used for case binding is described with reference to FIG. 5. The document file 17 includes cover page data 51, body page data 52, and spine page data 53. The cover page data 51 is composed of data for the front and back covers 43 and 45. The body page data 52 is composed of data for the body section 42. The document file 17 shown in FIG. 5 includes the cover page data 51 for four pages, the document page data 52 for two pages, and the spine page data 53 for one page, which are seven pages in total. Herein, these pages are assumed to be a front cover outer surface P1, a front cover inner surface P2, a body P3, a body P4, a back cover inner surface P5, and a back cover outer surface P6, and a spine P7. P1 to P7 indicate page numbers in the document file 17. The spine is disposed in the center of the page. Herein, the number of pages in the document file 17 is not limited to the example of FIG. 5.

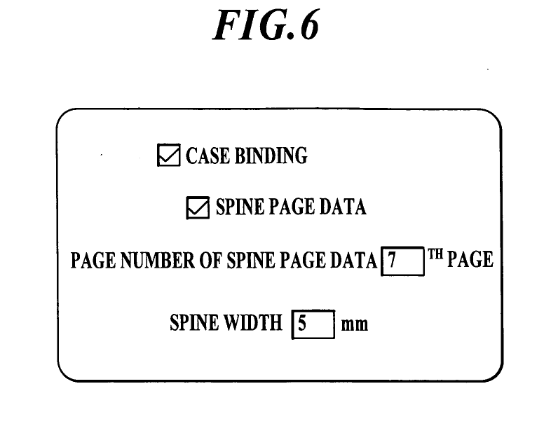

Next, a description is given of case binding setting with reference to FIG. 6. FIG. 6 shows a setting screen for case binding displayed in the display unit 12 of the information processing unit 1. The user can make setting concerning case binding based on setting information displayed in the display unit 12. For example, when case binding is performed, a check portion for “case binding” is checked through the input unit 11. When the spine page data 53 is necessary for the book, a check portion for “SPINE PAGE DATA” is checked. Furthermore, a page number of a page whose data is set to the spine page data 53 is inputted in a blank of “PAGE NUMBER OF SPINE PAGE DATA_”. For example, when the spine page data is at the 7th page, “7” is inputted in the blank through the input unit 11. Finally, the spine width is inputted in a blank of “SPINE WIDTH_mm”. For example, when the spine width is 5 mm, “5” is inputted through the input unit 11.

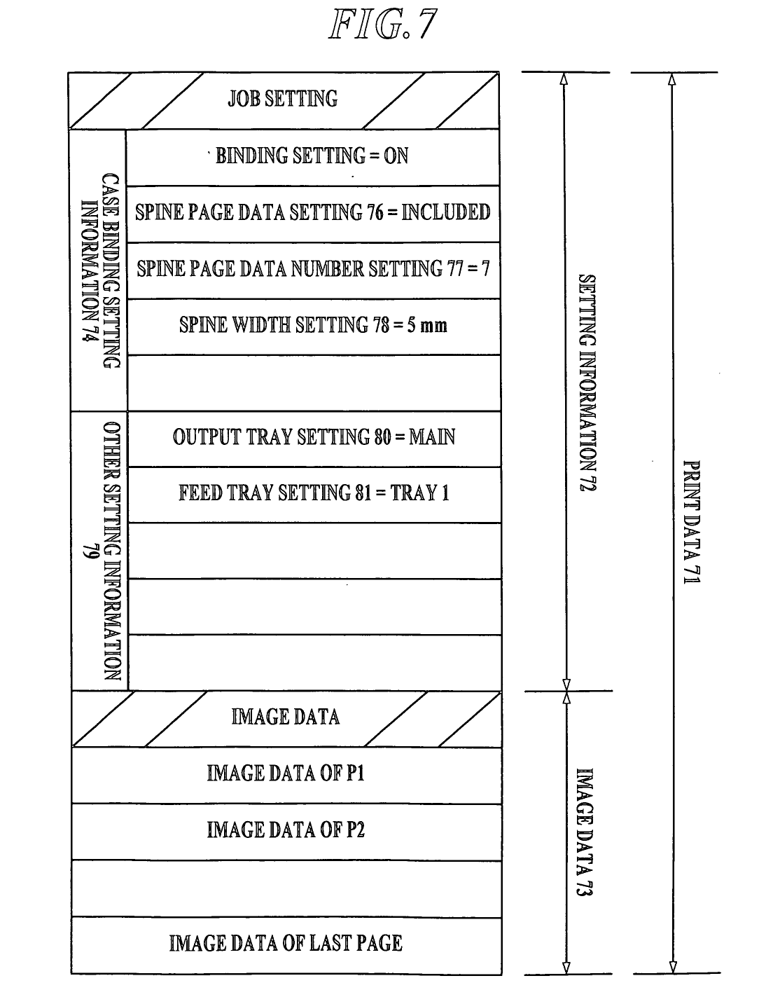

Next, a description is given of the configuration of the print data 71 with reference to FIG. 7. The print data 71 is printable data which is obtained by converting the document file 71. The print data 71 includes setting information 72 and image data 73. The setting information 72 is setting information required when case binding is performed. The setting information 72 includes case binding setting information 74 and other setting information 79. The case binding setting information 74 is setting information for a book created by case binding. The case binding setting information 74 includes a binding setting 75, a spine page data setting 76, a spine page data number setting 77, and a spine width setting 78. The binding setting 75 is setting information on whether to perform case binding. The spine page data setting 76 is setting information on whether to use the spine page data for the book. The spine page data number setting 77 is setting information of a number of a page in the document file 17 which is used as the spine page data. The spine width setting 78 is setting information of the width of the spine page. For example, information set in FIG. 6 is as follows: binding setting=ON, spine setting=INCLUDED, spine page number=7, and spine width=5 mm.

The other setting information 79 includes an output tray setting 80 and a feed tray setting 81. The output tray setting 80 is setting information of a place of an output tray in the image forming apparatus 2. The feed tray setting 81 is setting information of a place of a feed tray in the image forming apparatus 2. For example, when the output tray is a main tray, the output tray setting is set to “MAIN”. Similarly, when the feed tray is a tray 1, the feed tray setting is set to “TRAY 1”.

The image data 73 is composed of each type of page data of the document file 17. Each type of the page data is stored as the image data 73 composed of characters, pictures, photographs, and the like.

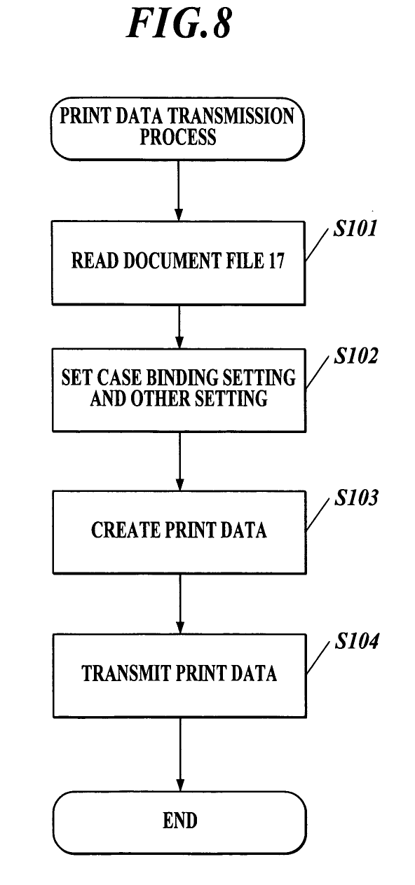

Next, a description is given of a flow of the print data transmission process executed in the controller 10 of the information processing apparatus 1 with reference to FIG. 8. The print data transmission process is a process to create print data 71 and transmit the same to the image forming apparatus 2.

For example, in the information processing apparatus 1, upon reception of an instruction to execute the print data transmission process through the input unit 11 or the like, the controller 10 executes the print data transmission process based on the print data transmission program read from the HDD 13 and properly loaded into the RAM.

First, the document file 17 used for case binding is selected and read from the HDD 13 (step S101). According to the instruction inputted by the user through the input unit 11, case binding setting and other setting are made (step S102). Herein, the case binding setting is to set the case binding setting information 74 including the binding setting 75, spine page data setting 76, spine page data number setting 77, and spine width setting 78, which are shown in FIG. 7. The other setting is to set the other setting information 79 including the output and feed tray settings 80 and 81.

Subsequently, the print data 71 including the case binding setting information 74 and other setting information 79 set in the step S102 is created (step S103). The created print data 71 is then transmitted to the image forming apparatus 2 (step S104). The print data transmission process is terminated after the print data 71 is transmitted to the image forming apparatus 2.

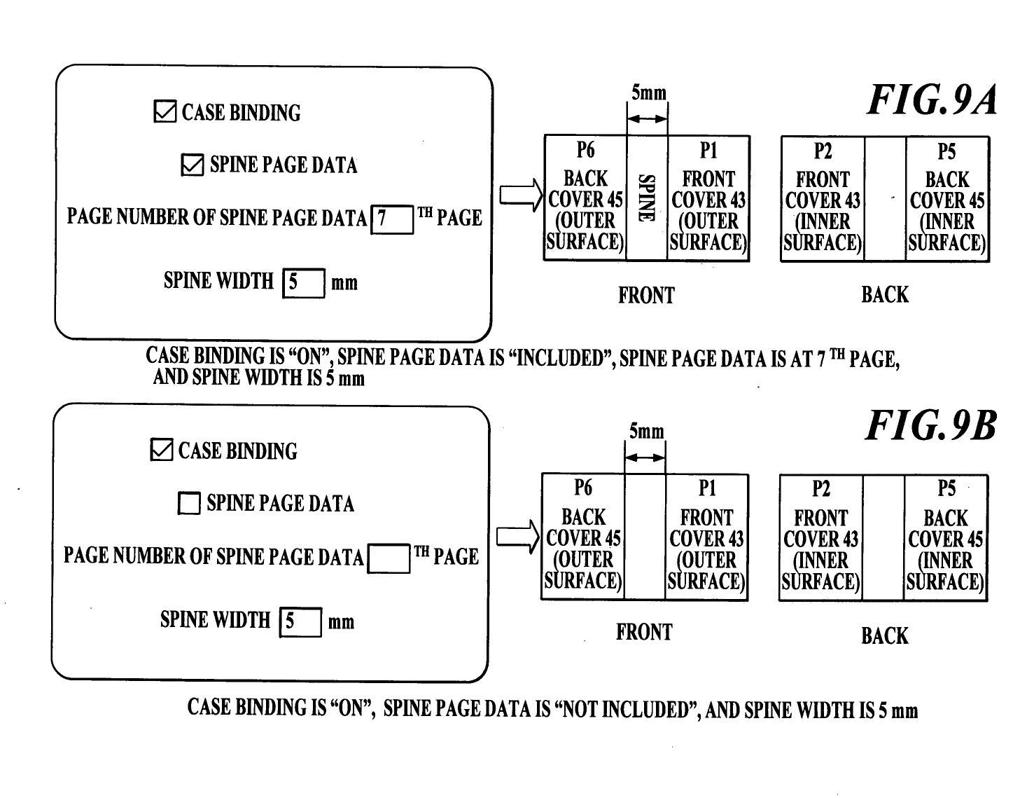

Next, a description is given of imposition processing executed in the image forming apparatus 2 with reference to FIGS. 9A and 9B. Herein, the imposition processing is to process the print data 71 such that the pages are sequentially arranged. FIG. 9A shows, for example, the case where case binding is “ON”, the spine page data is “INCLUDED”, the spine page data is at the 7th page, and the spine width is 5 mm. In the description, the document file 17 is assumed to be one shown in FIG. 5. In this case, the front of the cover section is composed of P6 as a last page of the cover page data 51, P1 as a first page of the cover page data 51, and P7 of the spine page data 53. The back of the cover section is composed of P2 and P5 of the cover page data 51. At this time, the imposition processing of the back of the spine is not performed.

FIG. 9B shows a case where imposition processing is performed when case binding is “ON”, the spine page data is “NOT INCLUDED”, and the spine width is 5 mm. In this case, the front of the cover section is composed of P6 as a last page of the cover page data 51 and P1 as a first page of the cover page data 51. The back of the cover section is composed of P2 and P5 of the cover page data 51.

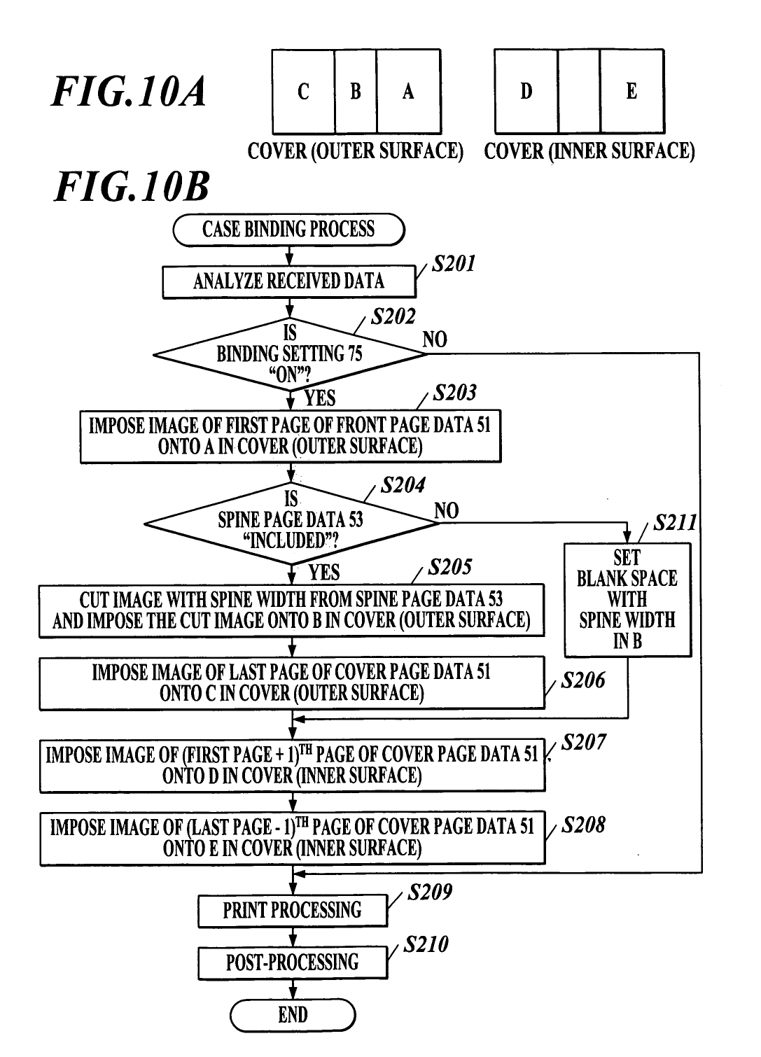

Next, a description is given of a case binding process executed by the image forming apparatus 2 with reference to FIGS. 10A and 10B. FIG. 10A shows a complementary view for explaining the case binding process. FIG. 10B shows a flow of the case binding process. The case binding process is a process to carry out case binding in the image forming apparatus 2.

FIG. 10A shows a view with page numbers of the cover (outer surface) being A and C and a page number of the spine being B. Moreover, FIG. 10A shows another view with page numbers of the cover (inner surface) being D and E. Hereinafter, the flow of the case binding process shown in FIG. 10B is described based on the page numbers shown in FIG. 10A.

For example, in the image forming apparatus 2, upon reception of the print data 71 from the information processing apparatus 1 through the communication unit 24 or the like, the controller 20 executes the case binding process based on the case binding program read from the ROM and properly loaded into the RAM.

First, the print data 71 transmitted from the information processing apparatus 1 is received through the communication unit 24. To reflect the received print data 71 on print settings within the image forming apparatus 2, the print data 71 is analyzed (step S201). Specifically, the setting information 72, which is Job setting information of the print data 71 shown in FIG. 7, is reflected on the print settings within the image forming apparatus 2.

Subsequently, with reference to the case binding setting information 74, it is judged whether the binding setting 75 is “ON” (step S202). When the binding setting 75 is “OFF” (step S202: NO), the process proceeds to step S209 later described.

When the binding setting 75 is “ON” (step S202: YES), an image of the first page of the cover page data 51 within the image data 73 is imposed onto A of the cover (outer surface) (step S203).

With reference to the case binding setting information 74, it is judged whether the spine page data 53 is “INCLUDED” (step S204). When the spine page data 53 is “NOT INCLUDED” (step S204: NO), a blank space with the spine width is set in B (step S211). After execution of the step S211, the process proceeds to step S206 later described.

In the step S204, when the spine page data 53 is “INCLUDED” (step S204: YES), an image with the spine width is cut from the spine page data 53 within the image data 73 and then imposed onto B in the cover (outer surface) (step S205).

Subsequently, an image of the last page of the cover page data 51 is imposed onto C in the cover (outer surface) (step S206). Furthermore, an image of a (first page+1)th page of the cover page data 51 is imposed onto D of the cover (inner surface) (step S207).

Subsequently, an image of a (last page−1)th page of the cover page data 51 is imposed onto E of the cover (inner surface) (step S208). Thereafter, print processing is performed (step S209). In the print processing, part of the print data 71 for the cover subjected to imposition processing in the steps S201 to S208 and S211 and the other part of the print data 71 are printed on the print medium.

Subsequently, post-processing is performed (step S210). In the post-processing, the body section 42 and spine 44 are glued for case binding. After execution of the step S210, the case binding process is terminated.

Hereinabove, according to the embodiment, printing of the spine is instructed using data of a certain page of the existing document file 17. This eliminates the need for an input operation performed for the spine when the printing is instructed, thus simplifying the print setting at case binding. Moreover, contents of the document file 17 can be applied to the spine 44. Accordingly, when the document file 17 is created by an application capable of handling images, an image can be printed on the spine 44.

Moreover, the instructions to print the spine and the body can be made using the same document file 17. This eliminates the need to prepare separate files such as data files for the spine and for the body, thus further simplifying print setting in case binding.

Moreover, the instructions to print the spine and the front and back covers can be made using the same document file 17. This eliminates the need to prepare separate files such as data files for the spine and for the front and back covers, thus further simplifying print setting in case binding.

Moreover, the certain page for the spine can be specified at print setting. Accordingly, the flexibility at print setting can be increased.

Moreover, the certain page for the spine is specified by specifying the page number of the document file 17 at print setting. Accordingly, the location of the page of the spine 44 in the document file 17 does not need to be conscious when the document file 17 is created.

Moreover, the necessity of printing of the spine can be specified at print setting. Accordingly, the flexibility of print setting for case binding can be ensured.

Moreover, setting of case binding can be easily made for a non-direct printing type image forming apparatus, which cannot directly print the document file 17.

Note that the above description of the embodiment is given of just examples of the information processing apparatus and program according to the present invention and the present invention is not limited to these.

For example, in the above embodiment, the page number for the spine page data is specified. However, it is possible to eliminate this specification and always treat the first or last page as the spine page data.

Moreover, the page for the spine page data is described as a certain page in the same document file but may be a certain page of a different document file.

In addition, the details of the configuration and operations of the information processing apparatus 1 in the above embodiment can be properly modified without departing from the scope of the present invention. For instance, instead of using data of a specified or certain page for printing the spine, data corresponding to a header/footer or a title of the data file can be used to print the spine.

The present U.S. patent application claims the priority of Japanese Patent Application No. 2006-024624 filed on Feb. 1, 2006, according to the Paris Convention, and the above Japanese Patent Application is the basis for correcting mistranslation of the present U.S. patent application.

What is claimed is:

1. An information processing apparatus, comprising:
a controller for instructing printing of a spine for case binding based on data of a certain page in a data file including data of a plurality of pages.

2. The information processing apparatus of claim 1, wherein
the controller instructs printing of a body for the case binding based on data of at least a part of pages other than the certain page in the data file.

3. The information processing apparatus of claim 1, wherein
the controller instructs printing of a front cover and a back cover for the case binding based on data of at least a part of pages other than the certain page in the data file.

4. The information processing apparatus of claim 1, further comprising:
an input unit for accepting an input instruction from a user, wherein
the controller specifies the certain page based on the input instruction accepted by the input unit.

5. The information processing apparatus of claim 4, wherein
the input unit accepts an entry of a page number in the data file, and
the controller specifies the certain page based on the page number accepted by the input unit.

6. The information processing apparatus of claim 4, wherein
the input unit accepts an indication from the user whether the printing for the spine is necessary, and
the controller instructs the printing of the spine for the case binding when the indication accepted from the input unit is that the printing of the spine is necessary.

7. The information processing apparatus of claim 1, wherein
the controller converts the data of the data file into print data provided for an image forming apparatus.

8. A recording medium storing a program allowing a computer to function as:
a controller for instructing printing of a spine for case binding based on data of a certain page in a data file including data of a plurality of pages.

9. The recording medium of claim 8, wherein
the controller instructs printing of a body for the case binding based on data of at least a part of pages other than the certain page in the data file.

10. The recording medium of claim 8, wherein
the controller instructs printing of a front cover and a back cover for the case binding based on data of at least a part of pages other than the certain page in the data file.

11. The recording medium of claim 8, wherein
the computer comprises an input unit for accepting an input instruction from a user, and
the controller specifies the certain page based on the input instruction accepted by the input unit.

12. The recording medium of claim 8, wherein
the input unit accepts an entry of a page number in the data file, and
the controller specifies the certain page based on the page number accepted by the input unit.

13. The recording medium of claim 11, wherein
the input unit accepts an indication from the user whether the printing for the spine is necessary, and
the controller instructs the printing of the spine for the case binding when the indication accepted from the input unit is that the printing of the spine is necessary.

14. The recording medium of claim 8, wherein
the controller converts the data of the data file into print data provided for an image forming apparatus.

15. An image processing apparatus comprises: a controller for instructing printing of a spine for case binding based on data of a certain part in a data file including data based on which printing of a body for the case biding is to be instructed.

16. A recording medium storing a program allowing a computer to function as:
a controller for instructing printing of a spine for case binding based on data of a certain part in a data file that includes data based on which printing of a body for the case biding is to be instructed.
